(19) United States
(12) Patent Application Publication
(10) Pub. No.: US 2006/0097885 A1
(43) Pub. Date: May 11, 2006

(54) Methods and apparatus for providing a power dashboard system

(76) Inventors: Uttam K. Sengupta, Portland, OR (US); William N. Schilit, Menlo Park, CA (US)

Correspondence Address: INTEL CORPORATION, P.O. BOX 5326, SANTA CLARA, CA, 95056-5326, US

(21) Appl. No.: 10/976,935

(22) Filed: Oct. 27, 2004

(51) Int. Cl. G08B 21/00; H04Q 7/20

(52) U.S. Cl. 340/636.1; 455/425

(57) ABSTRACT

Embodiments of methods and apparatus to provide a power dashboard system are generally described herein. Other embodiments may be described and claimed.

### TECHNICAL FIELD

The present disclosure relates generally to wireless communication systems, and more particularly, to methods and apparatus for providing a power dashboard system.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example power dashboard system.

FIG. 3 is a detailed block diagram representation of an example host device that may be used with the example power dashboard system of FIG. 2.

FIG. 4 is a diagram representation of an example power dashboard according to an embodiment of the methods and apparatus disclosed herein.

FIG. 5 is a flow diagram representation of one manner in which the example host device of FIG. 2 may be configured to identify client devices.

FIG. 6 is a flow diagram representation of one manner in which the example host device of FIG. 2 may be configured to monitor client devices.

FIG. 7 is a flow diagram representation of one manner in which the example host device of FIG. 2 may be configured to update the example power dashboard of FIG. 4.

FIG. 8 is a block diagram representation of an example processor system that may be used to implement the example power dashboard system of FIG. 2.

### DETAILED DESCRIPTION

As technology advances to provide greater mobility, more and more people are carrying and using multiple wireless electronic devices (i.e., an ensemble) for a variety of reasons such as work, education, and/or entertainment. For example, a person may carry and use an ensemble of portable wireless electronic devices including a laptop computer, a handheld computer, a tablet computer, a wireless (e.g., cordless or cellular) telephone, a pager, an audio and/or video player (e.g., an MP3 player and/or a digital video disc (DVD) player), a game device, a digital camera, a navigation device (e.g., a global positioning system (GPS) device), wireless peripherals (e.g., a keyboard, a mouse, a printer, etc.) and/or a remote control for a television, a DVD player, a car, a garage door, etc. Without a common, centrally-located user interface to provide power information associated with the ensemble, however, an individual may be required to inspect each wireless electronic device separately to assess the power status of all the devices. For example, an individual needs to look at each individual wireless electronic device of the ensemble to determine whether to replace or recharge the battery.

In general, methods and apparatus for providing a power dashboard system are described herein. According to one example embodiment, the power dashboard system may be configured to provide a centrally-located power dashboard indicative of power information associated with an ensemble of wireless electronic devices. In particular, the ensemble of wireless electronic devices may include a host device and one or more client devices. To provide the power dashboard system, the host device may receive power information associated with one or more client devices. For example, the power information may include device information and/or battery information. The host device may generate a user interface (e.g., a graphical user interface (GUI)) indicative of the power information associated with the client device(s). Based on the power information, the host device may identify a power characteristic associated with the client device(s). In one example, the host device may determine that a particular client device is using a battery as a power source. Accordingly, the host device may monitor the status of the battery associated with that client device and modify the power dashboard based on the battery status. Thus, the host device may provide greater convenience for individuals to view power information and/or to manage power consumption of an ensemble of wireless electronic devices by providing a centrally-located power dashboard having power information associated with the ensemble as described in detail below.

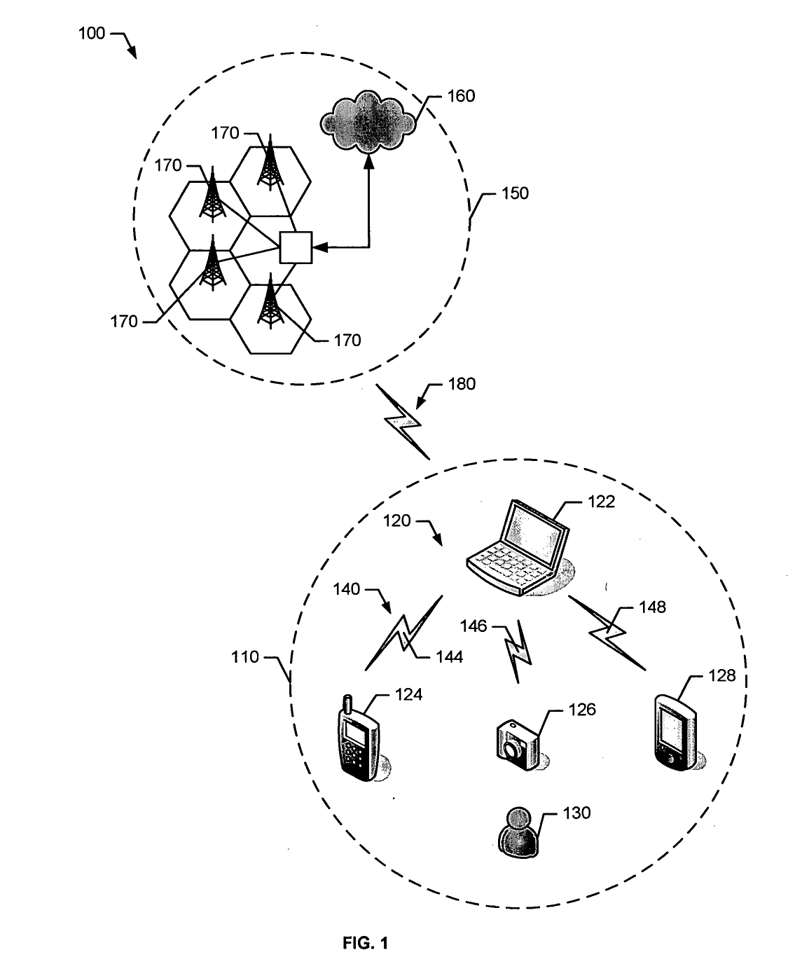

Referring to FIG. 1, an example wireless communication system 100 including a power dashboard system 110 is described herein. In particular, the power dashboard system 110 may include an ensemble of wireless electronic devices 120, generally shown as 122, 124, 126, and 128. For example, the ensemble of wireless electronic devices may include a laptop computer, a handheld computer, a tablet computer, a cellular telephone (e.g., a smart phone), a pager, an audio and/or video player, a game device, a digital camera, a navigation device, a wireless peripheral, a remote control, and/or other suitable wireless electronic devices. As noted above, an individual 130 may use and/or carry the ensemble of wireless electronic devices 120 to perform a variety of daily tasks for work, school, and/or leisure. Although FIG. 1 depicts four wireless electronic devices, the ensemble 120 may include additional or fewer wireless electronic devices used and/or carried by the individual 130. The methods and apparatus described herein are not limited in this regard.

The ensemble of wireless electronic devices 120 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate with each other via short-range or distance wireless communication links 140, generally shown as 144, 146, and 148. For example, the laptop computer 122 may implement OFDM modulation to transmit large amounts of digital data by splitting a radio frequency signal into multiple small sub-signals, which in turn, are transmitted simultaneously at different frequencies to the wireless telephone 124 via the short-range wireless communication link 144. In particular, the ensemble of wireless electronic devices 120 may use OFDM modulation as described in the 802.xx family of standards developed by the Institute of Electrical and Electronic Engineers (IEEE) and/or variations and evolutions of these standards (e.g., 802.11x, 802.15, 802.16x, etc.) to communicate via the short-range wireless communication links with each other. The ensemble of wireless electronic devices 120 may also operate in accordance with other suitable wireless communication protocols that require very low power such as Bluetooth, Ultra Wideband (UWB), Near Field Communication (NFC), and/or radio frequency identification (RFID) to communicate with each other via the short-range wireless communication links 140. Alternatively, the ensemble of wireless electronic devices 120 may communicate with each other via wired communication links (not shown). For example, the ensemble of wireless electronic devices 120 may use a serial interface, a parallel interface, a small computer system interface (SCSI), an Ethernet interface, a universal serial bus (USB) interface, a high performance serial bus interface (e.g., IEEE 1394 interface), and/or any other suitable type of wired interface to communicate with each other. The methods and apparatus described herein are not limited in this regard.

The wireless communication system 100 may also include a communication network 150 including a core network 160 and one or more radio access networks (RANs). Each RAN may include one or more base stations, generally shown as 170, and other radio components necessary to provide communication services to the ensemble of wireless electronic devices 120. The base stations 170 may operate in accordance with the applicable standard(s) for providing wireless communication services to the ensemble of wireless electronic devices 120. That is, each wireless electronic device in the ensemble 120 is configured to operate in accordance with at least one of several wireless communication protocols to communicate with the communication network 150 via a communication link 180. In particular, these wireless communication protocols may be based on analog, digital, and/or dual-mode communication system standards such as the Global System for Mobile Communications (GSM) standard, the Frequency Division Multiple Access (FDMA) standard, the Time Division Multiple Access (TDMA) standard, the Code Division Multiple Access (CDMA) standard, the Wideband CDMA (WCDMA) standard, the General Packet Radio Services (GPRS) standard, the Enhanced Data GSM Environment (EDGE) standard, the Universal Mobile Telecommunications System (UMTS) standard, variations and evolutions of these standards, and/or other suitable wireless communication standards.

Further, the wireless communication system 100 may include other wireless local area network (WLAN) devices, wireless metropolitan area network (WMAN) devices, and/or wireless wide area network (WWAN) devices (not shown). For example, the wireless communication system 100 may include devices such as network interface devices and peripherals (e.g., network interface cards (NICs)), access points (APs), gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. The methods and apparatus described herein are not limited in this regard.

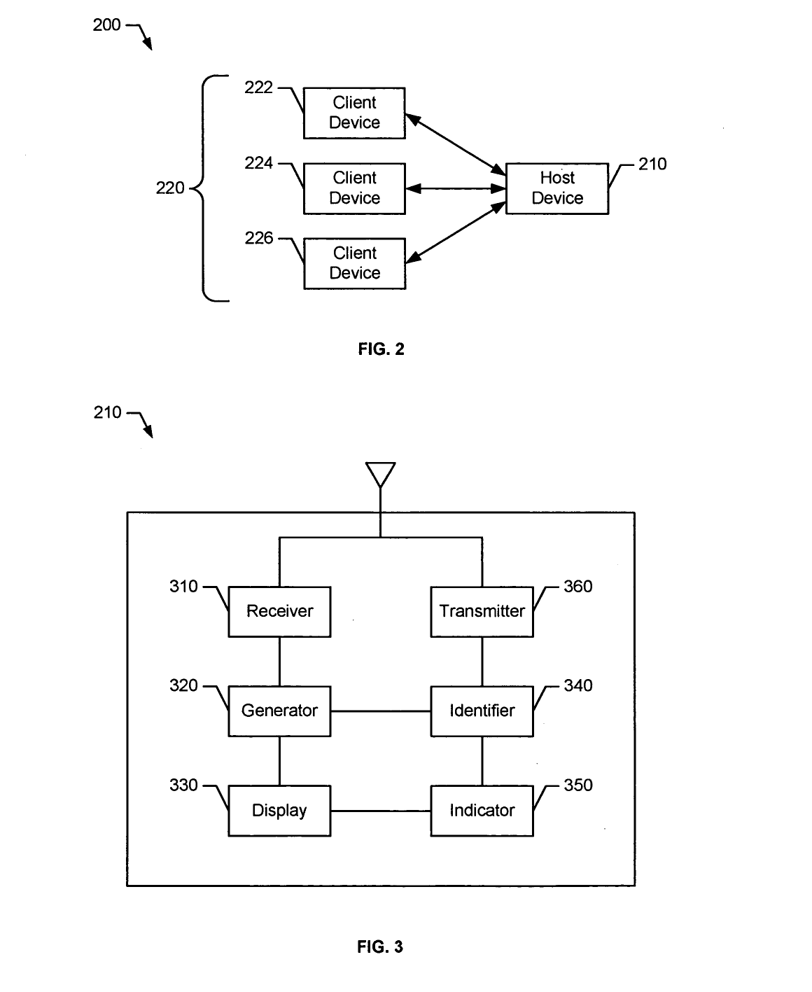

In the example of FIG. 2, a power dashboard system 200 may include a host device 210 and one or more client devices 220, generally shown as 222, 224, and 226. The host device 210 and the client devices 220 may form the ensemble of wireless electronic devices 120 as described above. For example, the host device 210 may be a laptop computer (e.g., one shown as 122 in FIG. 1), and the client devices 220 may include a wireless telephone, a digital camera, and/or a handheld computer (e.g., shown as 124, 126, and/or 128, respectively, in FIG. 1). Although FIG. 2 depicts one host device and three client devices, the power dashboard system 200 may include other variations and/or combinations of host and client devices. For example, the power dashboard system 200 may include two or more host devices. The methods and apparatus described herein are not limited in this regard.

The ensemble of wireless electronic devices 120 may automatically select one of the wireless electronic devices to operate as the host device 210 with the remaining wireless electronic device(s) operating as client devices 220. In particular, the ensemble of wireless electronic devices 120 may designate the host device 210 based on the power level of all of the wireless electronic devices in the ensemble 120 (e.g., battery life). For example, the wireless electronic device having the highest power level and/or a higher power level relative to all or some of the wireless electronic devices in the ensemble 120 may be selected as the host device 210. Thus, the remaining wireless electronic devices may conserve power by operating as client devices 220. The ensemble of wireless electronic devices 120 may also select one of the wireless electronic devices to operate as the host device 210 based on the power supply of the wireless electronic devices. For example, the wireless electronic device using an alternating current (AC) power supply (e.g., an outlet) as a primary power source instead of using a direct current (DC) power supply (e.g., a battery) may be designated as the host device 210. In addition, the ensemble of wireless electronic devices 120 may select one of the wireless electronic devices to operate as the host device 210 based on which wireless electronic device is currently being used or was last used by the individual 130. Further, each of the wireless electronic devices in the ensemble 120 may take turn to operate as the host device 210 for a predefined time period in a round-robin manner (e.g., a duty cycle of one hour). Alternatively, the individual 130 may designate one of the wireless electronic devices in the ensemble 120 as the host device 210. Although the examples described above disclose designating one of the wireless electronic devices in the ensemble 120 as the host device 210, two or more of the wireless electronic devices in the ensemble 120 may be designated as host devices 210. The methods and apparatus described herein are not limited in this regard.

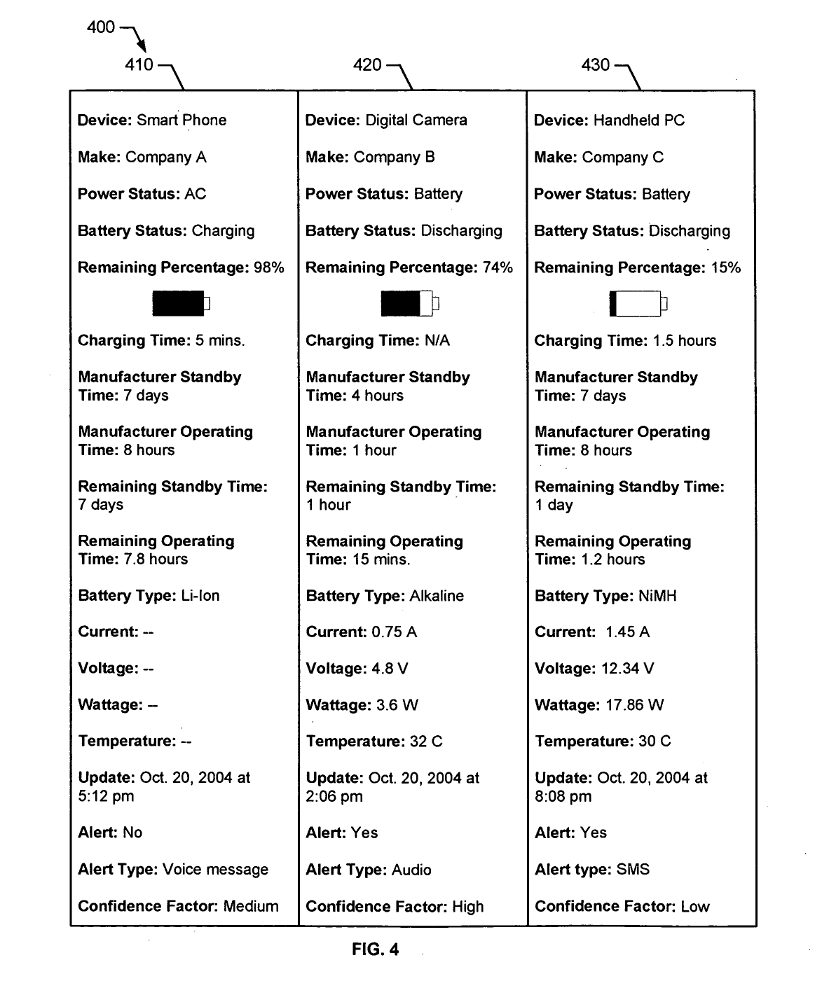

Referring to FIG. 3, the host device 210 may include a receiver 310, a generator 320, a display 330, an identifier 340, an indicator 350, and a transmitter 360. The receiver 310 is configured to receive power information associated with each of the client devices 220 (FIG. 2). As described in detail below, the power information may include device information and/or battery information. Based on the power information, the generator 320 may generate a power dashboard (e.g., 400 of FIG. 4) to provide a visual representation of the power information associated with client devices 220 via the display 330.

In the example of FIG. 4, a power dashboard 400 may include one or more user interfaces (e.g., GUIs) associated with the client devices 220, generally shown as 410, 420, and 430. For example, the first user interface 410 may provide power information associated with the client device 222 (e.g., a smart phone), the second user interface 420 may provide power information associated with the client device 224 (e.g., a digital camera), and the third user interface 430 may provide power information associated with the client device 226 (e.g., a handheld computer). Further, the power dashboard 400 may also include a user interface to provide power information associated with the host device 210 (not shown). Although FIG. 4 depicts three user interfaces, the power dashboard 400 may include more or less user interfaces. Based on the number of client devices 220, for example, the power dashboard 400 may include more or less user interfaces to provide power information associated with the ensemble of wireless electronic devices 120.

Each user interface of the power dashboard 400 may include one or more of windows, pull-down menus, buttons, scroll bars, iconic images, and/or other suitable components to provide information. As noted above, the power information associated with the client devices 220 may include device information, battery information, and/or user-defined information. In particular, the device information may include identification information (e.g., device type, device manufacturer, etc.), power status information (e.g., power supply), manufacturer and remaining standby time information (e.g., idle mode), manufacturer and remaining operating time information (e.g., talk time), time stamp (e.g., time of last update) and/or other suitable information associated with the client devices 220. For example, the power status information may indicate whether an alternating current (AC) power supply (e.g., an outlet) or a direct current (DC) power supply (e.g., a battery) is providing power to the client device 222.

The battery information may include battery manufacturer information, battery chemistry information (e.g., lithium-ion, alkaline, nickel-cadium, nickel-metal hydride, etc.), design information (e.g., capacity and/or voltage), identification information (e.g., serial number, bar-coding number, and/or name), battery status information (e.g., charging or discharging), recharge information (e.g., amount of time required for full charge), temperature information (e.g., Fahrenheit or Celsius), and/or other suitable information associated with a battery of the client devices 220. For example, the battery status information may include information indicative of the amount of time, percentage, and/or capacity that the battery may provide power to the client device 222, information indicative of current, voltage, wattage, and/or temperature associated with the battery, and/or other suitable information.

The user-defined information may include alert information and alert type information. In particular, the alert information may indicate whether to alert the individual 130 of a power characteristic associated with a client device. The alert type information may indicate a manner to alert the individual of the power characteristic associated with the client device. As described in detail below, the host device 210 (e.g., via the indicator 350) may alert the individual 130 that the battery needs to be replaced or recharged (e.g., low power), and/or the battery is malfunctioning (e.g., overheating). For example, the host device 210 may use short messaging service (SMS), enhanced messing service (EMS), multimedia messaging service (MMS) and/or other suitable methods to alert the individual 130. The methods and apparatus described herein are limited in this regard.

Turning back to FIG. 3, the identifier 340 is configured to identify power characteristic(s) associated with the client devices 220. For example, the identifier 340 may determine that the client device 222 switched from using a battery to using an AC power supply (e.g., via an AC adapter) as its primary power source. Accordingly, the generator 320 may modify the corresponding user interface (e.g., 410 of FIG. 4) to indicate the power characteristic associated with the client device 222. In another example, the identifier 340 may determine that the client device 226 is using a battery as a primary power source and proceed to monitor the status of the battery associated with the client device 226. In particular, the identifier 340 may determine whether the battery level of the battery is less than a predefined battery threshold. For example, the battery threshold may be defined to trigger an alert to indicate that the battery needs to be replaced or recharged (e.g., low power). Accordingly, the indicator 350 may generate the alert to notify the individual 130. For example, the indicator 350 may generate a visual and/or audible signal such as flashing, alternating, and/or blinking lights (e.g., a red light), a tone (e.g., a beep), a text, voice, and/or multimedia message, etc. Alternatively or in addition, the transmitter 360 may send an instruction to the client device 226 via the short-range wireless communication links 140 and/or the communication network 150 to generate the alert. For example, the client device 226 may receive an instruction from the host device 210 to generate a mechanically-actuated signal such as vibration at the client device 226. Thus, the power dashboard system 200 may provide greater convenience for the individual 130 to view, assess, and/or manage power consumption by the ensemble of wireless electronic devices 120.

While the components shown in FIG. 3 are depicted as separate blocks within the host device 210, the functions performed by some of these blocks may be integrated within a single semiconductor circuit or may be implemented using two or more separate integrated circuits. For example, although the receiver 310 and the transmitter 350 are depicted as separate blocks within the host device 210, the receiver 310 may be integrated into the transmitter 360 (e.g., a transceiver). The methods and apparatus described herein are not limited in this regard.

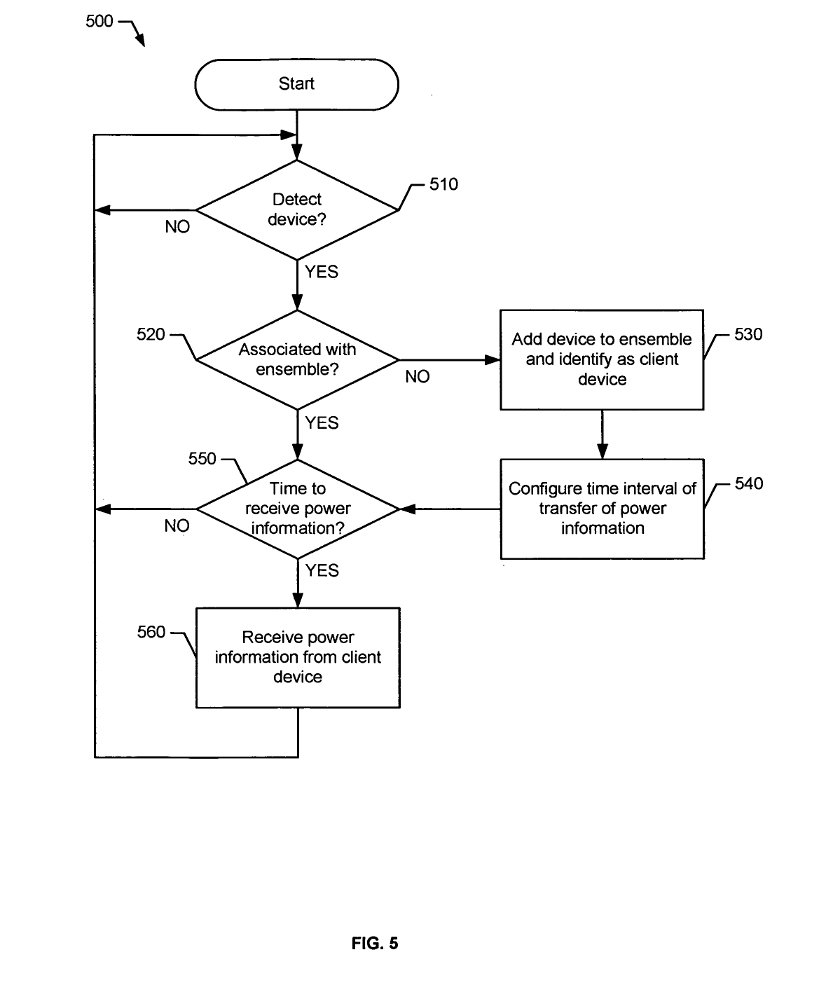

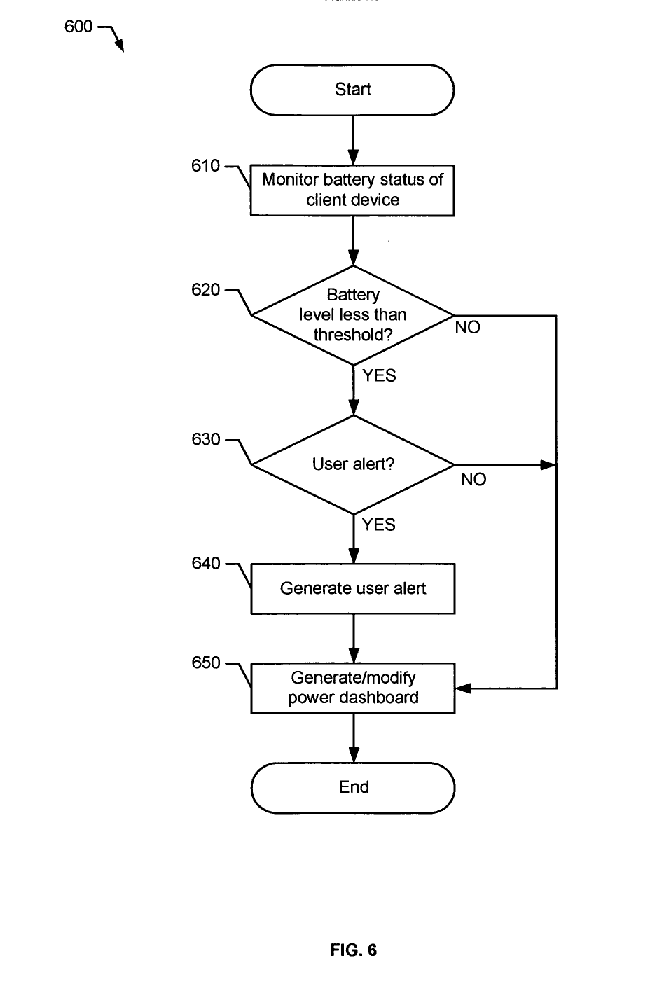

FIGS. 5 and 6 depict one manner in which the host device 210 of FIG. 2 may be configured to provide a power dashboard associated with the client devices 220 as described herein. The example processes 500 and 600 of FIGS. 5 and 6, respectively, may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in FIGS. 5 and 6, these actions can be performed in other temporal sequences. Again, the example processes 500 and 600 are merely provided and described in conjunction with the apparatus of FIGS. 1 and 2 as an example of one way to configure a wireless electronic device to operate as a host device 210 in the power dashboard system 200.

In the example of FIG. 5, the process 500 begins with the host device 210 monitoring for a wireless electronic device to operate as a client device (e.g., shown as 220 in FIG. 2) (block 510). As noted above, one or more of the wireless electronic devices of the ensemble 120 (FIG. 1) may be selected as the host device 210 (FIG. 2) in a variety of manners. Thus, any of the wireless electronic devices of the ensemble 120 (e.g., a laptop computer, a handheld computer, a tablet computer, a wireless telephone, a pager, an audio and/or video player, a game device, a digital camera, a navigation device, a remote control, etc.) may operate as the host device 210. If the host device 210 fails to detect a wireless electronic device, control returns to block 510 to continue monitoring for other wireless electronic devices to operate as client devices. Alternatively or in addition to such an active process by the host device 210 to identify client device(s), some wireless electronic device(s) may automatically register with the host device 210 to operate as client device(s) (e.g., a passive process).

Otherwise, if the host device 210 detects a wireless electronic device to operate as a client device at block 510, the host device 210 determines whether that particular wireless electronic device is associated with the ensemble 120 (block 520). If the detected wireless electronic device is not associated with the ensemble 120, the host device 210 associates the detected wireless electronic device with the ensemble 120 and identifies the detected wireless electronic device as one of the client devices 220 (e.g., 222 in FIG. 2) (block 530). The host device 210 may receive power information from the client device 222 periodically. In particular, the host device 210 may configure a time interval (e.g., a schedule to update every ten minutes) to receive power information from the client device 222 (block 540). Based on the time interval, the host device 210 determines whether to receive power information from the client device 222 (e.g., new and/or updated power information) (block 550). For example, the host device 210 may receive power information from the client device 222 by requesting for the power information periodically. The host device 210 may request for the power information in response to a user command by the individual 130. Alternatively or in addition, the client device 222 may automatically transmit the power information to the host device 210 when the host device 210 detects and identifies the client device 222 and/or when the client device 222 registers with the host device 210.

Referring back to block 550, if the host device 210 is scheduled to receive power information, the host device 210 receives the power information from the client device 222 (block 560) and control returns to block 510. Otherwise, if the host device 210 is not scheduled to receive power information, control directly returns to block 510 from block 540.

Turning back to block 520, if the host device 210 identifies the detected wireless electronic device as one of the client devices 220 (e.g., 222 in FIG. 2), control proceeds directly to block 550 as described above. In particular, If the host device 210 is scheduled to receive power information, the host device 210 receives power information from the client device 222 (block 560) and control returns to block 510. Otherwise, if the host device 210 is not scheduled to receive power information, control directly returns to block 510 from block 540.

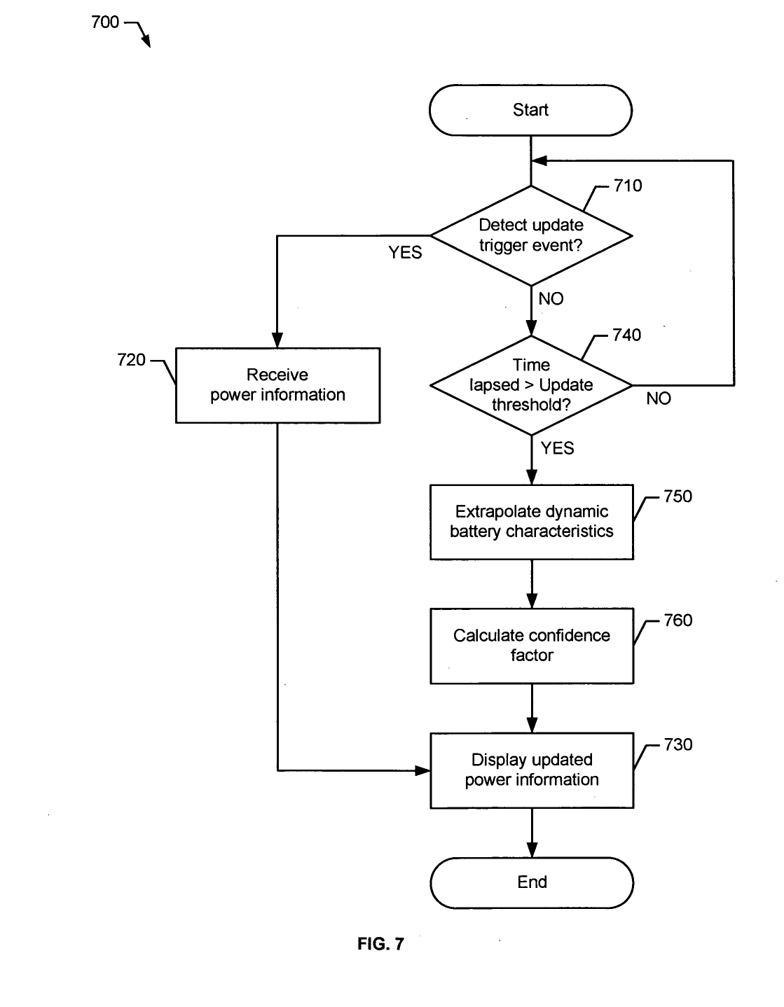

Turning to FIG. 6, the process 600 begins with the host device 210 (e.g., via the identifier 340 of FIG. 3) identifying power characteristic(s) associated with the client devices 220 by monitoring the battery status associated with each of the client devices 220 (block 610). In particular, the host device 210 may determine whether the battery level of the client device 222 is less than a predefined battery threshold (block 620). For example, the battery threshold may be defined to trigger an alert to indicate that the battery needs to be replaced or recharged (e.g., low power), and/or the battery is malfunctioning (e.g., overheating). If the battery level is greater than or equal to the battery threshold, the host device 210 may generate or modify a user interface (e.g., 410 of FIG. 4) to provide power information associated with the client device 222 (block 650). Likewise, the host device 210 may generate or modify other user interfaces (e.g., 420 and/or 430) of the power dashboard 400 to provide power information associated with other client device(s) 224 and/or 226. In one example, the host device 210 may update the power dashboard 400 as described below in connection with FIG. 7.

Otherwise if the host device 210 determines that the battery level is less than the battery threshold, the host device 210 determines whether the host device 210 is configured to generate a user alert to notify the individual 130 of a power characteristic associated with the client device 222 (block 630). For example, the user alert may notify the individual 130 that the battery of the client device 222 needs to be replaced or recharged. If the host device 210 is not configured to generate a user alert, the host device 210 proceeds directly to block 650 to generate/modify the power dashboard 400 accordingly. If the host device 210 is configured to generate a user alert, the host device 210 generates the user alert based on a predefined alert configuration (block 640). In particular, the host device 210 may generate (e.g., via the indicator 350 of FIG. 3) a visual and/or audible signal to indicate a power characteristic associated with the client device 222. For example, the indicator 350 may generate flashing, alternating, and/or blinking lights (e.g., a red light), a tone (e.g., a beep, a ring, etc.), and/or a text, voice, and/or multimedia message to indicate that the battery value is below the battery threshold. Alternatively or in addition, the host device 210 may instruct the client device 222 to generate the user alert. Based on the power characteristic, the host device 210 may generate or modify the user interface 410 associated with the client device 222 as described above in connection with block 650.

As noted above, the host device 210 may update the power dashboard 400 as described in connection with FIG. 7. The process 700 begins with the host device 210 (e.g., via the identifier 340) monitoring for an update trigger event (block 710). In one example, the host device 210 may automatically receive and/or request for the power information associated with the client device 222 periodically. Thus, the host device 210 may receive an update of the power information after a particular time interval (e.g., every ten minutes). In another example, the individual 130 may manually select for the host device 210 to receive the power information. If the host device 210 detects an update trigger event, the host device 210 may receive an update of the power information associated with the client device 222 (block 720). Accordingly, the host device 210 (e.g., via the generator 320) may generate updated power information on the display (730).

Otherwise if the host device 210 fails to detect an update trigger event at block 710, the host device 210 may determine whether an amount of time lapsed since the last reception of the power information is greater than an update threshold (block 740). The amount of time lapsed may be a difference between the current time and a time stamp associated with the last reception of the power information. The update threshold may be a time period less than the time interval configured in block 540 of FIG. 5. In one example, the update threshold may be one minute so that the host device 210 may update the power information every minute by extrapolating the power information as described below. If the time lapsed is less than or equal to the update threshold, control returns to block 710 from block 740. Otherwise if the time lapsed is greater than the update threshold, the host device 210 may extrapolate the power information associated with the client device 222 (block 750). In particular, the power information may include static battery characteristics and/or dynamic battery characteristics. For example, the static battery characteristics may include the battery information from the manufacturer of the battery such as the battery manufacturer information, the battery chemistry information, the design information, the identification information, the manufacturer standby and operating information, etc. In contrast, the dynamic battery characteristics may include the battery status information, the recharge information, the remaining standby and operating information, etc. Accordingly, the host device 210 may extrapolate one or more dynamic battery characteristics to generate an update of the power information (block 750). For example, the host device 210 may extrapolate the battery status, the remaining standby time, the remaining operating time, and/or the recharge time of the client device 222.

The host device 210 may also calculate a confidence factor associated with the updated power information based on the extrapolation of the dynamic battery characteristic(s) (block 760). In particular, the confidence factor may indicate a level of accuracy of the extrapolation based on the usage of the client device 222 (e.g., low, medium, or high). In one example, a navigation device may consume power at a relatively constant rate whereas a cellular telephone may consume power at a rate that varies based on the operation of the cellular telephone (e.g., roaming, receiving a multimedia stream, etc.). Thus, the host device 210 may generate a confidence factor associated with the navigation device that is greater than a confidence factor associated with the cellular telephone. In another example, a handheld computer may consume power at a rate that fluctuates relatively more than the rate of the cellular telephone because the handheld computer may operate multiple applications. Accordingly, the host device 210 may generate a confidence factor associated with the cellular telephone that is greater than a confidence factor associated with the handheld computer. Based on the extrapolation of the dynamic battery characteristics, the host device 210 may proceed to generate updated power information on the display (730).

While the processes 500, 600, and 700 are described above with examples in conjunction with the client device 222, the processes 500, 600, and 700 may be implemented so that the host device 210 may also provide a power dashboard having power information associated with the client device 224 and/or the client device 226. As a result, the host device 210 may provide a centrally-located power dashboard (e.g., 400 of FIG. 4) having power information associated with the client devices 220. Further, the host device 210 may generate the power dashboard on a local display and/or an external display (e.g., a monitor and/or a television).

Although the methods and apparatus disclosed herein are described with respect to wireless personal area networks (WPANs), the methods and apparatus disclosed herein may be applied to other suitable types of wireless communication networks. For example, the methods and apparatus disclosed herein may be applied to wireless local area networks (WLANs), wireless metropolitan area networks (WMANs), and/or wireless wide area networks (WWANs). The methods and apparatus described herein are not limited in this regard.

While the methods and apparatus disclosed herein are described with respect to portable wireless electronic devices, the methods and apparatus disclosed herein may be applied to other suitable types of wireless electronic devices. For example, the methods and apparatus disclosed herein may be applied to relatively-stationary wireless electronic devices such as a desktop computer, an external display, an access point device, a mesh point device, a smoke detector, a carbon monoxide detector, a security sensor, a television, a household appliance, etc.

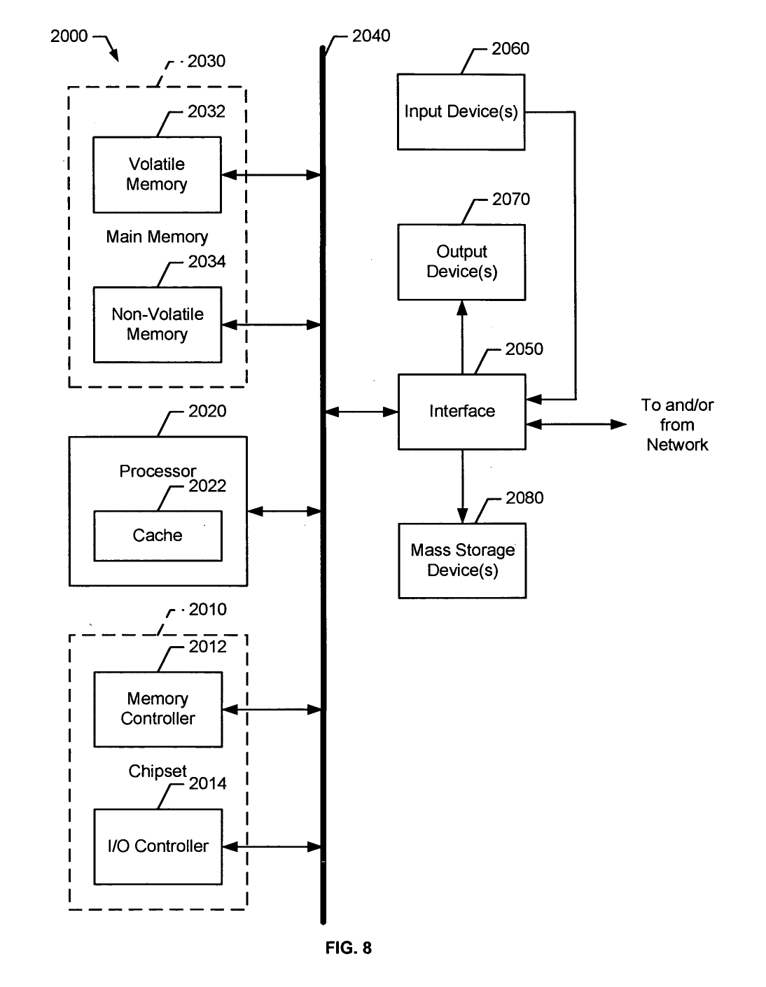

FIG. 8 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 8 includes a chipset 2010, which includes a memory controller 2012 and an input/output (I/O) controller 2014. As is well known, a chipset typically provides memory and I/O management functions, as well as a plurality of general purpose and/or special purpose registers, timers, etc. that are accessible or used by a processor 2020. The processor 2020 is implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 includes a cache 2022, which may be implemented using a first-level unified cache (L1), a second-level unified cache (L2), a third-level unified cache (L3), and/or any other suitable structures to store data.

As is conventional, the memory controller 2012 performs functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 also includes an interface circuit 2050 that is coupled to the bus 2040. The interface circuit 2050 may be implemented using any type of well known interface standard such as an Ethernet interface, a universal serial bus (USB), a third generation input/output interface (3GIO) interface, and/or any other suitable type of interface.

One or more input devices 2060 are connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 are also connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050, thus, typically includes, among other things, a graphics driver card.

The processor system 2000 also includes one or more mass storage devices 2080 to store software and data. Examples of such mass storage device(s) 2080 include floppy disks and drives, hard disk drives, compact disks and drives, and digital versatile disks (DVD) and drives.

The interface circuit 2050 also includes a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network is typically controlled by the I/O controller 2014 in a conventional manner. In particular, the I/O controller 2014 performs functions that enable the processor 2020 to communicate with the input device(s) 2060, the output device(s) 2070, the mass storage device(s) 2080 and/or the network via the bus 2040 and the interface circuit 2050.

While the components shown in FIG. 8 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
receiving power information associated with a first wireless electronic device at a second wireless electronic device, the first and second wireless electronic devices being associated with an ensemble of wireless electronic devices; and
generating a user interface indicative of the power information via the second wireless electronic device.

2. A method as defined in claim 1, wherein receiving the power information associated with the first wireless electronic device at the second wireless electronic device comprises receiving one or more of device information or battery information associated with the first wireless electronic device.

3. A method as defined in claim 1 further comprising identifying a power characteristic associated with the first wireless electronic device at the second wireless electronic device based on the power information.

4. A method as defined in claim 1 further comprising identifying a condition indicative of a battery level of a battery associated with the first wireless electronic device being less than a threshold.

5. A method as defined in claim 1 further comprising generating an alert indicative of a power characteristic associated with the first wireless electronic device via the second wireless electronic device.

6. A method as defined in claim 1 further comprising transmitting one or more instructions to generate an alert indicative of a power characteristic associated with the first wireless electronic device via the second wireless electronic device.

7. A method as defined in claim 1 further comprising detecting the first wireless electronic device via a wireless communication link in accordance with a short-range wireless communication protocol and associating the first wireless electronic device with the ensemble of wireless electronic devices.

8. A method as defined in claim 1 further comprising extrapolating one or more battery characteristics associated with a battery of the first wireless device, and updating the user interface based on an extrapolation of the one or more battery characteristics.

9. A method as defined in claim 1, wherein the ensemble of wireless electronic devices comprises one or more of a laptop computer, a handheld computer, a tablet computer, a personal data assistant, a wireless telephone, a pager, an audio/video player, a game device, a digital camera, a navigation device, a remote control, a detecting device, a sensing device, or a communication point device.

10. An article of manufacture including content, which when accessed, causes a machine to:
receive power information associated with a first wireless electronic device at a second wireless electronic device, the first and second wireless electronic devices being associated with an ensemble of wireless electronic devices; and
generate a user interface indicative of the power information via the second wireless electronic device.

11. An article of manufacture as defined in claim 10, wherein the content, when accessed, causes the machine to receive the power information associated with the first wireless electronic device at the second wireless electronic device by receiving one or more of device information or battery information associated with the first wireless electronic device.

12. An article of manufacture as defined in claim 10, wherein the content, when accessed, causes the machine to identify a power characteristic associated with the first wireless electronic device at the second wireless electronic device based on the power information.

13. An article of manufacture as defined in claim 10, wherein the content, when accessed, causes the machine to identify a condition indicative of a battery level of a battery associated with the first wireless electronic device being less than a threshold.

14. An article of manufacture as defined in claim 10, wherein the content, when accessed, causes the machine to generate an alert indicative of a power characteristic via the second wireless electronic device.

15. An article of manufacture as defined in claim 10, wherein the content, when accessed, causes the machine transmitting one or more instructions to generate an alert indicative of a power characteristic associated with the first wireless electronic device via the second wireless electronic device.

16. An article of manufacture as defined in claim 10, wherein the content, when accessed, cause the machine to detect the first wireless electronic device via a wireless communication link in accordance with a short-range wireless communication protocol and associate the first wireless electronic device with the ensemble of wireless electronic devices.

17. An article of manufacture as defined in claim 10, wherein the content, when accessed, cause the machine to extrapolate one or more battery characteristics associated with a battery of the first wireless device, and to update the user interface based on an extrapolation of the one or more battery characteristics.

18. An apparatus comprising:
a receiver to receive power information associated with a first wireless electronic device at a second wireless electronic device, the first and second wireless electronic devices being associated with an ensemble of wireless electronic devices; and
a generator to generate a user interface indicative of the power information via the second wireless electronic device.

19. An apparatus as defined in claim 18, wherein the power information comprises one or more of device information or battery information.

20. An apparatus as defined in claim 18 further comprising an identifier to identify a power characteristic associated with the first wireless electronic device at the second wireless electronic device based on the power information.

21. An apparatus as defined in claim 18 further comprising an identifier to identify a condition indicative of a battery level of a battery associated with the first wireless electronic device being less than a threshold.

22. An apparatus as defined in claim 18 further comprising an identifier to identify an extrapolation of one or more battery characteristics associated with a battery of the first wireless device and to update the user interface based on the extrapolation.

23. An apparatus as defined in claim 18 further comprising an indicator to generate an alert indicative of a power characteristic associated with the first wireless electronic device via the second wireless electronic device.

24. An apparatus as defined in claim 18 further comprising an identifier to detect the first wireless electronic device via a wireless communication link in accordance with a short-range wireless communication protocol and associate the first wireless electronic device with the ensemble of wireless electronic devices.

25. An apparatus as defined in claim 18 further comprising a transmitter to transmit one or more instructions to generate an alert indicative of a power characteristic associated with the first wireless electronic device via the second wireless electronic device.

26. A system comprising:
a flash memory; and
a processor coupled to the flash memory to receive power information associated with a first wireless electronic device at a second wireless electronic device; and
a generator to generate a user interface indicative of the power information via the second wireless electronic device,
wherein the first and second wireless electronic devices being associated with an ensemble of wireless electronic devices.

27. A system as defined in claim 26, wherein the power information comprises one or more of device information or battery information.

28. A system as defined in claim 26, wherein the processor is configured to identify a power characteristic associated with the first wireless electronic device at the second wireless electronic device based on the power information.

29. A system as defined in claim 26, wherein the processor is configured to generate an alert indicative of a power characteristic via the second wireless electronic device.

30. A system as defined in claim 26, wherein the processor is configured to extrapolate one or more battery characteristics associated with a battery of the first wireless device and to update the user interface based on an extrapolation of one or more battery characteristics.
